(19) United States
(12) Patent Application Publication
(10) Pub. No.: US 2017/0088928 A1
(43) Pub. Date: Mar. 30, 2017

(54) SLURRY FOR THERMAL SPRAYING

(71) Applicant: FUJIMI INCORPORATED, Kiyosu-shi (JP)

(72) Inventors: Hiroyuki IBE, Aichi (JP); Kazuyuki TSUZUKI, Aichi (JP); Takaya MASUDA, Aichi (JP)

(73) Assignee: FUJIMI INCORPORATED, Kiyosu-shi (JP)

(21) Appl. No.: 15/258,131

(22) Filed: Sep. 7, 2016

(30) Foreign Application Priority Data
Sep. 25, 2015 (JP) 2015-188834

(51) Int. Cl. C23C 4/04; C09D 7/12; C09D 5/02

(52) U.S. Cl. CPC C23C 4/04; C09D 5/024; C09D 7/1216

(57) ABSTRACT

To provide a slurry for thermal spraying capable of forming a favorable sprayed coating. The present invention provides a slurry for thermal spraying including spray particles including at least one material selected from the group consisting of ceramics, inorganic compounds, cermets, and metals and a dispersion medium. Here, the spray particles have an average particle size of 0.01 μm or more and 10 μm or less and are contained in the slurry for thermal spraying at a proportion of 10% by mass or more and 70% by mass or less. In the slurry for thermal spraying, the spray particles have a zeta potential of −200 mV or more and 200 mV or less.

### BACKGROUND OF THE INVENTION

Field of the Invention

The present invention relates to a slurry for thermal spraying including spray particles.

Description of the Related Art

Techniques of covering the surfaces of substrates with various materials to impart novel functions have been used in various fields. As one of the surface covering techniques, a thermal spraying method is known, for example. In the method, spray particles including a ceramic, a cermet, a metal, or a similar material are softened or melted by combustion or electric energy, and are sprayed to the surface of a substrate, thereby giving a sprayed coating including such a material (for example, see Patent Document 1).

In the thermal spraying, spray particles as a coating material are typically fed in a powder form to a thermal spraying apparatus. In recent years, spray particles are dispersed in a dispersion medium and fed in a slurry (including a suspension) form to a thermal spraying apparatus. As a conventional technique relating to the slurry for thermal spraying, Patent Document 2 is exemplified.

### CITATION LIST

### Patent Literature

PTL 1: JP 2014-240511 A

PTL 2: JP 2010-150617 A

### SUMMARY OF THE INVENTION

A slurry for thermal spraying in which spray particles are dispersed in a dispersion medium cannot maintain the dispersion state of the spray particles during storage of the slurry due to a difference in specific gravity of materials thereof or particle sizes, and the spray particles may sediment to form precipitates in some cases. Spray particles that have precipitated have no flowability, and thus a slurry for thermal spraying that is likely to generate precipitates is unsuitable as the material for thermal spraying. In addition, when a larger amount of spray particles precipitate, the feed amount of a slurry for thermal spraying may be reduced, or a slurry may cause clogging in a feeding device.

In such circumstances, the inventors of the present invention have repeatedly conducted various studies, and consequently have found that even a slurry for thermal spraying capable of generating precipitates can form a high quality sprayed coating and is suitable as a material for thermal spraying when spray particles can be satisfactory dispersed in a dispersion medium. The present invention is completed on the basis of the above findings and intends to provide a slurry for thermal spraying capable of forming a favorable sprayed coating. The present invention further intends to provide a sprayed coating formed by using the slurry for thermal spraying.

The present invention provides a slurry for thermal spraying having the following characteristics to solve the above problems. The slurry for thermal spraying includes spray particles including at least one material selected from the group consisting of ceramics, inorganic compounds, cermets, and metals and a dispersion medium. Here, the spray particles have an average particle size of 0.01 μm or more and 10 μm or less, and are contained in the slurry for thermal spraying at a proportion of 10% by mass or more and 70% by mass or less. In the slurry for thermal spraying, the spray particles have a zeta potential of −200 mV or more and 200 mV or less.

When having such a structure, a slurry for thermal spraying allows the spray particles to be in a good dispersion state, and this can improve feeding performance when the slurry is fed to a thermal spraying apparatus. Accordingly, a slurry for thermal spraying that can be stably fed in appropriate dispersion and flow conditions to a thermal spraying apparatus can be achieved. Consequently, a slurry for thermal spraying capable of forming a uniform and dense sprayed coating can be provided.

In a preferred aspect of the slurry for thermal spraying disclosed here, the slurry further includes a dispersant. When having such a structure, a slurry for thermal spraying in which the dispersion stability of the spray particles is more improved is provided.

In a preferred aspect of the slurry for thermal spraying disclosed here, at least some of the spray particles include an yttrium oxyfluoride. When having such a structure, a slurry for thermal spraying enables the formation of a sprayed coating having excellent plasma erosion resistance.

In a preferred aspect of the slurry for thermal spraying disclosed here, at least some of the spray particles include a rare earth halide. When the slurry for thermal spraying having such a structure is thermally sprayed, a sprayed coating having novel characteristics due to the rare earth halide can be formed. In the present description, the “average particle size” of spray particles is an average particle size (sphere equivalent diameter) calculated on the basis of specific surface area, for spray particles having an average particle size of less than 1 μm. The average particle size D is a value calculated in accordance with the equation: D=6/(ρS) where

S is the specific surface area of spray particles and p is the density of the material constituting spray particles. For example, when the spray particles are yttria (yttrium oxide: Y₂O₃), the average particle size can be calculated where the density ρ is 5.01 g/cm³. The specific surface area of spray particles can be a value determined by a gas adsorption method, for example, and can be measured in accordance with JIS Z 8830: 2013 (1509277: 2010)

“Determination of the specific surface area of powders (solids) by gas adsorption”. For example, the specific surface area of spray particles can be determined by using a surface area analyzer, trade name “FlowSorb II 2300” manufactured by Micromeritics. For spray particles having an average particle size of 1 μm or more, the particle size at an integrated value of 50% in volumetric particle size distribution (50% cumulative particle size) determined with a particle size distribution analyzer based on the laser scattering/diffraction method is used as the “average particle size”.

In a preferred aspect of the slurry for thermal spraying disclosed here, the slurry for thermal spraying has a viscosity of 1,000 mPa·s or less. When having such a structure, a slurry for thermal spraying in which spray particles are prevented from sedimenting and the flow state is appropriately conditioned is provided.

In the present description, the viscosity of a slurry for thermal spraying is a viscosity at room temperature (25° C.) determined by using a rotational viscometer. Such a viscosity can be a value determined by using a Brookfield viscometer (for example, manufactured by Rion, Viscotester VT-03F), for example.

In a preferred aspect of the slurry for thermal spraying disclosed here, the dispersion medium is an aqueous dispersion medium. When having such a structure, a material for thermal spraying that have a lower environmental load is provided because the amount of organic solvents used is reduced or the use is unnecessary. In addition, when an aqueous dispersion medium is used, a resulting sprayed coating has a smoother surface and a lower surface roughness as compared with the case using a nonaqueous dispersion medium is used, and this is advantageous.

In a preferred aspect of the slurry for thermal spraying disclosed here, the dispersion medium is a nonaqueous dispersion medium. When having such a structure, a material for thermal spraying that can be thermally sprayed at a lower temperature is provided. When a nonaqueous dispersion medium is used, a resulting sprayed coating has a lower porosity as compared with the case using an aqueous dispersion medium, and this is advantageous.

In another aspect, the present invention provides a sprayed coating including a thermal spray product of any of the above slurries for thermal spraying. The sprayed coating can be formed by thermal spraying at high efficiency by using particles for thermal spraying having a comparatively small average particle size, for example. Accordingly, the sprayed coating can be formed as a dense sprayed coating having high adhesiveness and coating strength.

### DESCRIPTION OF THE PREFERRED EMBODIMENTS

Preferred embodiments of the present invention will now be described. Matters not specifically mentioned in the present description but required for carrying out the present invention can be understood by a person skilled in the art on the basis of teachings on the implementation of the invention described in the present description and common general knowledge at the time of the patent application. The present invention can be carried out on the basis of the contents disclosed in the present description and common general knowledge in the field.

[Slurry for Thermal Spraying]

The slurry for thermal spraying disclosed here essentially includes spray particles including at least one material selected from the group consisting of ceramics, inorganic compounds, cermets, and metals and a dispersion medium. In the slurry for thermal spraying, the zeta potential of the spray particles that are dispersed in the dispersion medium is −200 mV or more and 200 mV or less. In other words, the spray particles in the slurry for thermal spraying are so prepared as to have an absolute zeta potential of 200 mV or less. The zeta potential is preferably −180 mV or more and 180 mV or less, more preferably −150 mV or more and 150 mV or less, and even more preferably, for example, 0 mV or more and 150 mV or less.

It is generally believed that when a dispersion system including particles and a dispersion medium has a larger absolute zeta potential, the dispersibility of the particles is higher, thus the particles are unlikely to agglomerate, and the particles are dispersed in the liquid at a uniform concentration. In other words, repulsive force is generated between the respective particles, and the dispersion state is maintained in a primary particle state. Thus, the zeta potential of particles in a dispersion system is set to several hundreds mV or more in many cases.

In contrast, in the dispersion system of a slurry for thermal spraying including spray particles of the above material and a dispersion medium, the spray particles can be difficult to maintain a dispersion state. When the spray particles include a ceramic, an inorganic compound, a cermet, a metal, or a similar material having a larger specific gravity than those of resin materials and the like, the tendency becomes much higher. In the technique disclosed here, the inventors have found that when spray particles agglomerate to some extent, but the particles in a secondary particle state do not largely repel each other or agglomerate, and the repulsive force is cancelled by the attractive force or the difference of the forces is small, the spray particles are in a state suitable for thermal spraying. The zeta potential of the spray particles in the slurry for thermal spraying (hereinafter, also simply called “zeta potential”) is therefore specified to be in a range from −200 mV to 200 mV. In the dispersion system of the slurry for thermal spraying in such a condition, a stable dispersion state can be maintained in a flow state even when spray particles precipitate or agglomerate. In the dispersion state, the spray particles may agglomerate to form secondary particles.

The zeta potential of spray particles is used as an index representing flowability (mobility) of the spray particles in the slurry for thermal spraying disclosed here. Hence, in measurement of the zeta potential, a value determined without any pretreatment such as dilution of a slurry for thermal spraying to be measured can be adopted. The measurement method of the zeta potential can be a known measurement technique such as a microscope electrophoresis method, a rotational diffraction grating method, a laser doppler electrophoresis method, an ultrasonic vibration potential method, and an electrokinetic sonic amplitude method. Of them, the ultrasonic vibration potential method that can determine the zeta potential of spray particles in a high-concentration thermal spraying slurry can be preferably adopted because ultrasonic waves are applied to vibrate the spray particles in a thermal spraying slurry and the zeta potential is measured.

(Particles for Thermal Spraying)

The spray particles can include spray particles including at least one material selected from the group consisting of ceramics, inorganic compounds, cermets, and metals.

The ceramic is not limited to particular ceramics. The ceramic can be exemplified by oxide ceramics including various metal oxides, carbide ceramics including of metal carbides, nitride ceramics including metal nitrides, and nonoxide ceramics including nonoxides such as metal borides, metal fluorides, metal hydroxides, metal carbonates, and metal phosphates.

The oxide ceramic is not limited to particular ceramics, and various metal oxides can be used. Examples of the metallic element constituting such an oxide ceramic include metalloid elements such as B, Si, Ge, Sb, and Bi; typical metal elements such as Na, Mg, Ca, Sr, Ba, Zn, Al, Ga, In, Sn, Pb, and P; transition metal elements such as Sc, Y, Ti, Zr, Hf, V, Nb, Ta, Cr, Mo, W, Mn, Fe, Co, Ni, Cu, Ag, and Au; and lanthanoid elements such as La, Ce, Pr, Nd, Pm, Sm, Eu, Gd, Tb, Dy, Ho, Er, Tu, Yb, and Lu. These elements can be used singly or in combination of two or more of them. Specifically preferred are one or more elements selected from Mg, Y, Ti, Zr, Cr, Mn, Fe, Zn, Al, and Er. The oxide ceramic disclosed here also preferably contains, in addition to the above metallic element, a halogen element such as F, Cl, Br, and I.

More specifically, examples of the oxide ceramic include alumina, zirconia, yttria, chromia, titania, cobaltite, magnesia, silica, calcia, ceria, ferrite, spinel, zircon, forsterite, steatite, cordierite, mullite, nickel oxide, silver oxide, copper oxide, zinc oxide, gallium oxide, strontium oxide, scandium oxide, samarium oxide, bismuth oxide, lanthanum oxide, lutetium oxide, hafnium oxide, vanadium oxide, niobium oxide, tungsten oxide, manganese oxide, tantalum oxide, terbium oxide, europium oxide, neodymium oxide, tin oxide, antimony oxide, antimony-containing tin oxide, indium oxide, barium titanate, lead titanate, lead zirconate titanate, Mn-Zn ferrite, Ni-Zn ferrite, sialon, tin-containing indium oxide, zirconium oxide aluminate, zirconium oxide silicate, hafnium oxide aluminate, hafnium oxide silicate, titanium oxide silicate, lanthanum oxide silicate, lanthanum oxide aluminate, yttrium oxide silicate, titanium oxide silicate, tantalum oxide silicate, yttrium oxyfluoride, yttrium oxychloride, yttrium oxybromide, and yttrium oxyiodide.

Examples of the nonoxide ceramic include carbide ceramics such as tungsten carbide, chromium carbide, niobium carbide, vanadium carbide, tantalum carbide, titanium carbide, zirconium carbide, hafnium carbide, silicon carbide, and boron carbide; nitride ceramics such as silicon nitride and aluminum nitride; boride ceramics such as hafnium boride, zirconium boride, tantalum boride, and titanium boride; hydroxide ceramics such as hydroxyapatite; and phosphoric acid ceramics such as calcium phosphate.

The inorganic compound is not limited to particular compounds, and can be exemplified by semiconductors such as silicon, and particles (optionally powders) of inorganic compounds such as various carbides, nitrides, and borides. The inorganic compound may be a crystalline compound or an amorphous compound. Specifically preferred examples of the inorganic compound include halides of rare earth elements.

In the rare earth halide, the rare earth element (RE) is not limited to particular rare earth elements and can be appropriately selected from scandium, yttrium, and lanthanoid elements. Specifically, the rare earth element is exemplified by scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). These elements may be used singly or in combination of two or more of them. Preferred examples include Y, La, Gd, Tb, Eu, Yb, Dy, and Ce from the viewpoint of improving the plasma erosion resistance or prices, for example. These rare earth elements may be contained singly or in combination of two or more of them.

The halogen element (X) is also not limited to particular elements and may be any element belonging to Group 17 in the periodic table. Specifically, halogen elements such as fluorine (F), chlorine (Cl), bromine (Br), iodine (I), and astatine (At) may be used singly or in combination of two or more of them. The halogen element is preferably F, Cl, or Br. These halogen elements may be contained singly or in combination of two or more of them. As such a rare earth halide, fluorides of various rare earth elements, typified by yttrium fluoride (YF₃), are exemplified as preferred examples.

The metal is not limited to particular metals and is exemplified by various elemental metals exemplified as the constituent elements of the above ceramics and alloys including such an element and one or more other elements. The elemental metal is typically exemplified by nickel, copper, aluminum, iron, chromium, niobium, molybdenum, tin, and lead. The alloy is exemplified by nickel-based alloys, chromium-based alloys, copper-based alloys, and steels. Here, the alloy encompasses substances that include the above metallic element and one or more other elements and exhibit metallic characteristics, and may be any of solid solutions, intermetallic compounds, and mixtures of them in terms of mixing manner.

The cermet is not limited to particular cermets, and can be general composite materials prepared by bonding ceramic particles with a metal matrix. The cermet can be a composite of the above exemplified ceramic and the metal. More specifically, the cermet is typically exemplified by composites (cermets) of titanium compound ceramics such as titanium carbide (TiC) and titanium carbonitride (TiCN), carbide ceramics such as tungsten carbide (WC) and chromium carbide (CrC), and oxide ceramics such as alumina (Al₂O₃) with metals such as iron (Fe), chromium (Cr), molybdenum (Mo), and nickel (Ni). Such a cermet can be prepared by burning intended ceramic particles and metal particles in an appropriate atmosphere, for example.

The spray particles disclosed here preferably include spray particles including specifically at least an yttrium oxyfluoride among the above ceramics, inorganic compounds, cermets, and metals. The yttrium oxyfluoride can be a compound containing at least yttrium (Y), oxygen (O), and fluorine (F) as constituent elements. The ratio of yttrium (Y), oxygen (O), and fluorine (F) constituting the yttrium oxyfluoride is not limited to particular values.

For example, the molar ratio of fluorine to oxygen (F/O) is not limited to particular values. As a preferred example, the molar ratio (F/O) can be 1, for example, and is preferably more than 1. Specifically, for example, the molar ratio is preferably 1.2 or more, more preferably 1.3 or more, and particularly preferably 1.4 or more. The upper limit of the molar ratio (F/O) is not limited to particular values and can be 3 or less, for example. As a more preferred example, the molar ratio of fluorine to oxygen (F/O) is, for example, 1.3 or more and 1.53 or less (for example, 1.4 or more and 1.52 or less), 1.55 or more and 1.68 or less (for example, 1.58 or more and 1.65 or less), or 1.7 or more and 1.8 or less (for example, 1.72 or more and 1.78 or less). In such a condition, thermal stability can be improved at the time of thermal spraying, and thus such a ratio is preferred. When spray particles have such a higher ratio of fluorine to oxygen, a sprayed coating as a thermal spray product of the slurry for thermal spraying can obtain excellent erosion resistance against halogen plasma, and thus such spray particles are preferred.

In the technique disclosed here, the halogen plasma is typically a plasma generated by using a plasma generating gas including a halogen-containing gas (halogenated compound gas). Specific examples of the halogen-containing gas include fluorine-containing gases used, for example, in a dry etching step at the time of production of semiconductor substrates, such as SF₆, CF₄, CHF₃, ClF₃, and HF; chlorine-containing gases such as Cl₂, BCl₃, and HCl;

bromine-containing gases such as HBr; and iodine-containing gases such as HI. These gases can be used singly or as a mixture of two or more of them, and the plasma generated by using such a gas can be typically exemplified. Such a gas may be a mixed gas with an inert gas such as argon (Ar).

The molar ratio of yttrium to oxygen (Y/O) is not limited to particular values. As a preferred example, the molar ratio (Y/O) can be 1 and is preferably more than 1. Specifically, for example, the molar ratio is preferably 1.05 or more, more preferably 1.1 or more, and particularly preferably 1.15 or more. The upper limit of the molar ratio (Y/O) is not limited to particular values and can be 1.5 or less, for example. As a more preferred example, the molar ratio of yttrium to oxygen (Y/O) is, for example, 1.1 or more and 1.18 or less (for example, 1.12 or more and 1.17 or less), 1.18 or more and 1.22 or less (for example, 1.19 or more and 1.21 or less), or 1.22 or more and 1.3 or less (for example, 1.23 or more and 1.27 or less).

In such a condition, thermal stability can be improved at the time of thermal spraying, and thus such a ratio is preferred. When a slurry for thermal spraying containing spray particles having such a small ratio of an oxygen element to yttrium is thermally sprayed, the spray particles can be prevented from undergoing oxidative decomposition, and thus such spray particles are preferred. For example, in a sprayed coating as a thermal spray product of the slurry for thermal spraying, the formation of yttrium oxides (for example, Y₂O₃) by oxidation of an yttrium component can be suppressed, and thus such spray particles are preferred.

More specifically, the yttrium oxyfluoride may be a compound represented by YOF as the chemical composition where the ratio of yttrium, oxygen, and fluorine is 1:1:1. The yttrium oxyfluoride may also be Y₅O₄F₇, Y₆O₅F₈, Y₇O₆F₉, Y₁₇O₁₄F₂₃, and the like that are comparatively, thermodynamically stable and are represented by the general formula: Y₁O₁₋ₙF₁₊₂ₙ (where n satisfies 0.12≦n≦0.22, for example). In particular, Y₅O₄F₇, Y₅O₅F₈, Y₇O₆F₉, and the like in which the molar ratios (Y/O) and (F/O) are within the above preferred ranges can form a denser sprayed coating having higher hardness and having excellent plasma erosion resistance against halogen gas plasma, and thus are preferred. Such an yttrium oxyfluoride may include of a monophase of any one of the compounds or may include a mixed phase, a solid solution, or a compound of two or more compounds in combination or a mixture of them.

The slurry for thermal spraying disclosed here may contain spray particles include other ceramics, inorganic compounds, metals, or cermets in addition to the spray particles including the yttrium oxyfluoride. However, for example, in the slurry for thermal spraying used for forming a sprayed coating having excellent plasma erosion resistance, the spray particles preferably contain a larger amount of the yttrium oxyfluoride. The yttrium oxyhalide is preferably contained in the spray particles at a high proportion of 77% by mass or more. The yttrium oxyfluoride has much higher plasma erosion resistance than that of yttria (Y₂O₃) that has been known as a material having high plasma erosion resistance. When contained even in a small amount, the yttrium oxyfluoride greatly improves the plasma erosion resistance. When contained in such a large amount as described above, the yttrium oxyfluoride can achieve extremely excellent plasma resistance. Such a condition is therefore preferred. The proportion of the yttrium oxyfluoride is more preferably 80% by mass or more (more than 80% by mass), even more preferably 85% by mass or more (more than 85% by mass), further preferably 90% by mass or more (more than 90% by mass), and further more preferably 95% by mass or more (more than 95% by mass). For example, the proportion is particularly preferably, substantially 100% by mass (100% except unavoidable impurities). When containing the yttrium oxyfluoride at such a high proportion, the spray particles can contain other substances that are likely to become particles.

When spray particles contain the yttrium oxyfluoride, the whole spray particles can include of the yttrium oxyfluoride in a preferred embodiment. However, when containing an yttrium oxyfluoride having a composition comparatively susceptible to oxidation (for example, Y₁O₁F₁), the spray particles preferably contain a halide of a rare earth element at a proportion of 23% by mass or less, for example. The rare earth halide contained in spray particles can be oxidized during thermal spraying to form an oxide of the rare earth element in a sprayed coating. For example, yttrium fluoride can be oxidized during thermal spraying to form yttrium oxide in a sprayed coating. The yttrium oxide can become the generation source of particles in an environment exposed to halogen plasma. Meanwhile, an yttrium oxyfluoride (for example, Y₁O₁F₁) can also be oxidized during thermal spraying to form yttrium oxide in a sprayed coating. When the yttrium oxyfluoride is present together with a small amount of a rare earth halide, the oxidation of the yttrium oxyfluoride can be suppressed by the rare earth halide, and thus the coexistence is preferred. However, an excess proportion of a rare earth halide results in an increase of the particle source as described above, and thus a proportion of more than 23% by mass is unfavorable because the plasma erosion resistance is deteriorated. From such a viewpoint, the proportion of the rare earth halide is preferably 20% by mass or less, more preferably 15% by mass or less, even more preferably 10% by mass or less, and, for example, preferably 5% by mass or less. In a more preferred embodiment of the material for thermal spraying disclosed here, substantially no rare earth halide (for example, yttrium fluoride) can be contained.

Spray particles including yttrium oxide (Y₂O₃) form a white sprayed coating and can be a preferred material in order to form a sprayed coating having environmental barrier properties or erosion resistance against typical plasma. Spray particles can also be so constituted as to contain substantially no oxide of yttrium (yttrium oxide: Y₂O₃) component so that a sprayed coating as a thermal spray product can achieve plasma resistance at a higher level. For example, the slurry for thermal spraying containing spray particles including the yttrium oxyfluoride preferably contains no spray particles including yttrium oxide. Yttrium oxide included in spray particles can remain as yttrium oxide in a sprayed coating formed by thermal spraying. The yttrium oxide has extremely low plasma resistance as compared with yttrium oxyfluorides and rare earth halides, for example, as described above. Hence, an area containing yttrium oxide is likely to form a brittle altered layer when exposed to a plasma environment, and the altered layer is likely to generate extremely fine particles and to be released. The fine particles may deposit on a semiconductor substrate. On this account, in the slurry for thermal spraying disclosed here, yttrium oxide, which can become a particle source, is preferably excluded.

In the present description, “containing substantially no component” means that the proportion of the component (here, yttrium oxide) is 5% by mass or less, preferably 3% by mass or less, and, for example, 1% by mass or less. Such a structure can be ascertained by that diffraction peaks based on the component are not detected in X-ray diffraction analysis of the spray particles, for example.

When spray particles contain multiple (for example, a, where a is a natural number and a ≧2) compositions of yttrium oxyfluorides and/or rare earth halides, the proportion of each composition can be calculated by the following procedure. First, the compositions of compounds constituting spray particles are identified by X-ray diffraction analysis. In this analysis, valence numbers (element ratio) of the yttrium oxyfluoride are needed to be identified.

For example, when a single type of yttrium oxyfluoride is present and the remaining is YF₃ in a material for thermal spraying, the oxygen content in the material for thermal spraying is determined with, for example, an oxygen/nitrogen/hydrogen analyzer (for example, manufactured by LECO, ONH836). From the obtained oxygen concentration, the content of the yttrium oxyfluoride can be quantitatively determined.

When two or more types of yttrium oxyfluorides are present or an oxygen-containing compound such as yttrium oxide is mixed, the proportion of each compound can be quantitatively determined by a calibration curve method, for example. Specifically, several samples are prepared by changing the proportion of each compound, and each sample is subjected to X-ray diffraction analysis. A calibration curve indicating the relation between a main peak intensity and the content of a corresponding compound is prepared. On the basis of the calibration curve, the content is quantitatively determined from the main peak intensities of yttrium oxyfluorides in XRD of a material for thermal spraying to be measured.

As for the molar ratio (F/O) and the molar ratio (Y/O) in the above yttrium oxyfluoride, the molar ratio (Fa/Oa) and the molar ratio (Ya/Oa) of each composition are calculated, then the molar ratio (Fa/Oa) and the molar ratio (Ya/Oa) are multiplied by the abundance ratio of the corresponding composition, and the results are summed up (the weighted sum is calculated), thereby enabling the calculation of the molar ratio (F/O) and the molar ratio (Y/O) of all the yttrium oxyhalides in spray particles.

The materials constituting the spray particles may include other elements in addition to the above exemplified elements, in order to improve functionalities, for example. Each of the ceramic, the inorganic compound, the cermet, and the metal may be a mixture or a composite including two or more compositions. Two or more of the ceramic, the inorganic compound, the cermet, and the metal may be mixed.

The spray particles may be any particles that have an average particle size of about 30 μm or less, and the lower limit of the average particle size is also not limited to particular values. Here, spray particles having a comparatively small average particle size are preferably used in the slurry for thermal spraying disclosed here because the improvement effect of the feeding performance is obvious. From such a viewpoint, the average particle size of the spray particles can be, for example, 10 μm or less and can be preferably 8 μm or less, more preferably 6 μm or less, and, for example, 5 μm or less. The lower limit of the average particle size can be, for example, 0.01 μm or more and can be preferably 0.05 μm or more, more preferably 0.1 μm or more, and, for example, 0.5 μm or more, in consideration of the viscosity or flowability of the slurry for thermal spraying. When the average particle size is about 1 μm or more, the viscosity of the slurry for thermal spraying can be prevented from excessively increasing, and thus such a condition is preferred.

For example, when fine spray particles having an average particle size of about 10 μm or less are used as the thermal spraying material, the specific surface area is increased, and accordingly the flowability can be reduced, typically. Such a thermal spraying material thus has poor feeding performance to a thermal spraying apparatus, and the thermal spraying material adheres to a feed line, for example, and is difficult to feed to a thermal spraying apparatus. Hence, the coating formability may deteriorate. In addition, such a thermal spraying material has a small mass, thus can be hit by a thermal spraying flame or a jet stream, and can be difficult to fly appropriately. In contrast, in the slurry for thermal spraying disclosed here, for example, spray particles even having an average particle size of 10 μm or less are prepared as a slurry in consideration of feeding performance to a thermal spraying apparatus. Thus, the slurry is prevented from adhering to a feed line or the like and can maintain high coating formability. In addition, the particles are fed to a flame or a jet stream in a slurry state, thus are not hit by the flame or the jet, and can fly with the stream. Moreover, a dispersion medium is removed during flying. Hence, the thermal spraying efficiency is maintained at a higher level, and a sprayed coating can be formed.

(Dispersion Medium)

The slurry for thermal spraying disclosed here can include an aqueous dispersion medium or a nonaqueous dispersion medium.

Examples of the aqueous dispersion medium include water and mixtures of water and a water-soluble organic solvent (mixed aqueous solutions). As the water, tap water, ion-exchanged water (deionized water), distilled water, and pure water can be used, for example. As the organic solvent except water constituting the mixed aqueous solution, one or more of organic solvents that are homogeneously miscible with water (for example, lower alcohols and lower ketones having 1 to 4 carbon atoms) can be appropriately selected and used. As the aqueous solvent, for example, a mixed aqueous solution containing water at 80% by mass or more (more preferably 90% by mass or more, even more preferably 95% by mass or more) in the aqueous solvent is preferably used. Specifically preferred examples include aqueous solvents substantially including water (for example, tap water, distilled water, pure water, and purified water).

As the nonaqueous solvent, organic solvents containing no water are typically exemplified. Such an organic solvent is not limited to particular solvents, and is exemplified by alcohols such as methanol, ethanol, n-propyl alcohol, and isopropyl alcohol; and organic solvents such as toluene, hexane, and kerosene. These solvents can be used singly or in combination of two or more of them.

The type and the composition of the dispersion medium to be used can be appropriately selected according to a thermal spray method of the slurry for thermal spraying, for example. In other words, for example, when the slurry for thermal spraying is thermally sprayed by a high velocity flame spraying method, any of the aqueous solvents and the nonaqueous solvents can be used. When an aqueous dispersion medium is used, the surface roughness of a resulting sprayed coating is improved (a smoother surface) as compared with the case using a nonaqueous dispersion medium, and this is advantageous. When a nonaqueous dispersion medium is used, a resulting sprayed coating has a lower porosity as compared with the case using an aqueous dispersion medium, and this is advantageous.

The slurry for thermal spraying can be prepared by mixing spray particles with the above dispersion medium and dispersing the mixture. For the dispersion, a mixer, a disperser, and the like including a homogenizer and a blade type stirrer can be used.

The slurry for thermal spraying disclosed here may further contain a dispersant as needed. Here, the dispersant is generally a compound capable of improving the dispersion stability of spray particles in a dispersion medium in the slurry for thermal spraying. Such a dispersant can be a compound that essentially affects spray particles or can be a compound that affects a dispersion medium, for example. The dispersant can also be a compound that affects spray particles or a dispersion medium to improve the surface wettability of the spray particles, a compound that deflocculates spray particles, or a compound that suppresses or prevents re-agglomeration of deflocculated spray particles, for example.

The dispersant can be appropriately selected from aqueous dispersants and nonaqueous dispersants according to the above dispersion medium, and used. Such a dispersant may be any of polymer dispersants (including polymer surfactant-type dispersants), surfactant-type dispersants (also called low molecular dispersants), and inorganic dispersants, and these dispersants may be any of anionic dispersants, cationic dispersants, and nonionic dispersants. In other words, the dispersant can have at least one functional group of anionic groups, cationic groups, and nonionic groups in the molecular structure thereof.

Examples of the aqueous polymer dispersant include dispersants including polycarboxylic acid compounds such as sodium polycarboxylate, ammonium polycarboxylate, and polycarboxylic acid polymers; dispersants including sulfonic acid compounds such as sodium polystyrene sulfonate, ammonium polystyrene sulfonate, sodium polyisoprene sulfonate, ammonium polyisoprene sulfonate, sodium naphthalenesulfonate, ammonium naphthalenesulfonate, sodium salts of naphthalenesulfonic acid formalin condensates, and ammonium salts of naphthalenesulfonic acid formalin condensates; and dispersants including polyethylene glycol compounds. Examples of the nonaqueous polymer dispersant include dispersants including acrylic compounds such as polyacrylates, polymethacrylates, polyacrylamide, and polymethacrylamide; dispersants including polycarboxylic acid partial alkyl ester compounds that are polycarboxylic acids partially having alkyl ester bonds; dispersants including polyalkyl ether compounds such as polyoxyalkylene alkyl ethers prepared by addition polymerization of an aliphatic higher alcohol with ethylene oxide; and dispersants including polyalkylene polyamine compounds.

As apparent from the description, for example, the concept of “polycarboxylic acid compounds” in the present description encompasses the polycarboxylic acid compounds and salts thereof. The same applies to the other compounds. A compound classified into one of the aqueous dispersant and the nonaqueous dispersant for convenience can be used as the other of the nonaqueous dispersant and the aqueous dispersant depending on the detailed chemical structure or the usage conditions thereof.

Examples of the aqueous surfactant-type dispersant (also called low molecular dispersant) include dispersants including alkylsulfonic acid compounds, dispersants including quaternary ammonium compounds, and dispersants including alkylene oxide compounds. Examples of the nonaqueous surfactant-type dispersant include dispersants including polyhydric alcohol ester compounds, dispersants including alkyl polyamine compounds, and dispersants including imidazoline compounds such as alkyl imidazolines.

Examples of the aqueous inorganic dispersant include phosphates such as orthophosphates, metaphosphates, polyphosphates, pyrophosphates, tripolyphosphates, hexametaphosphates, and organic phosphates; iron salts such as ferric sulfate, ferrous sulfate, ferric chloride, and ferrous chloride; aluminum salts such as aluminum sulfate, polyaluminum chloride, and sodium aluminate; and calcium salts such as calcium sulfate, calcium hydroxide, and dibasic calcium phosphate.

The above dispersants may be used singly or in combination of two or more of them. In the technique disclosed here, an alkyl imidazoline compound-containing dispersant and a dispersant including a polyacrylic acid compound are preferably used in combination as a specific example. The content of the dispersant varies with the composition (physical properties) and the like of spray particles, and thus is not necessarily limited, but is typically, roughly within a range from 0.01 to 10% by mass where the mass of spray particles is 100% by mass.

(Other Optional Components)

The slurry for thermal spraying may further contain a viscosity modifier as needed. Here, the viscosity modifier is a compound capable of reducing or increasing the viscosity of a slurry for thermal spraying. By appropriately adjusting the viscosity of a slurry for thermal spraying, a reduction in the feeding performance of the slurry for thermal spraying can be suppressed even when the content of spray particles in the slurry for thermal spraying is comparatively high. Examples of the compound usable as the viscosity modifier include nonionic polymers including polyethers such as polyethylene glycol, polyvinyl alcohol, polyvinylpyrrolidone, polyvinyl acetate, polyvinyl benzyltrimethylammonium chloride, aqueous urethane resins, gum arabic, chitosan, cellulose, crystalline cellulose, methylcellulose, ethylcellulose, hydroxyethylcellulose, carboxymethylcellulose, carboxymethylcellulose ammonium, carboxymethylcellulose, carboxyvinyl polymers, lignin sulfonate, and starch. The content of the viscosity modifier can be within a range from 0.01 to 10% by mass where the mass of spray particles is 100% by mass.

The slurry for thermal spraying may further contain an agglomerating agent (also called a redispersibility improvement agent or a caking inhibitor, for example) as needed. Here, the agglomerating agent is a compound capable of agglomerating spray particles in the slurry for thermal spraying. Typically, the agglomerating agent is a compound capable of flocculating spray particles in the slurry for thermal spraying. Depending on physical properties of spray particles, when the slurry for thermal spraying contains an agglomerating agent (including a redispersibility improvement agent, a caking inhibitor, and the like), spray particles precipitate while the agglomerating agent is interposed between the spray particles, thus the spray particles that have precipitated are prevented from aggregating, and the redispersibility is improved. In other words, even when spray particles precipitate, the respective particles are prevented from densely agglomerating (or aggregating) (also called caking or hard-caking). Hence, when a slurry is transferred to a thermal spraying apparatus or the like, a turbulent flow is generated in a slurry, and comparatively easily redisperses precipitates. Thus, sedimentation during transfer is suppressed, and the feeding performance to a thermal spraying apparatus is improved. In addition, when a slurry for thermal spraying is stored in a container for a long time and spray particles precipitate due to long time standing, the spray particles can be redispersed by a simple shaking operation such as vertical shaking of a container by hand, for example. Hence, the feeding performance to a thermal spraying apparatus is improved.

The agglomerating agent or the redispersibility improvement agent may be any of aluminum-containing compounds, iron-containing compounds, phosphoric acid-containing compounds, and organic compounds. Examples of the aluminum-containing compound include aluminum sulfate, aluminum chloride, and polyaluminum chloride (also called PAC and PAC1). Examples of the iron-containing compound include ferric chloride and polyferric sulfate. Examples of the phosphoric acid-containing compound include sodium pyrophosphate. The organic compound may be any of anionic compounds, cationic compounds, and nonionic compounds, and is exemplified by organic acids such as malic acid, succinic acid, citric acid, maleic acid, and maleic anhydride, diallyldimethylammonium chloride polymers, lauryltrimethylammonium chloride, naphthalenesulfonic acid condensates, sodium triisopropylnaphthalenesulfonate, sodium polystyrene sulfonate, isobutylene-maleic acid copolymers, and carboxyvinyl polymers.

The slurry for thermal spraying may further contain an antifoaming agent as needed. Here, the antifoaming agent is a compound capable of preventing foam from generating in a slurry for thermal spraying at the time of production of a slurry for thermal spraying or thermal spraying or is a compound capable of eliminating foam generated in a slurry for thermal spraying. Examples of the antifoaming agent include silicone oil, silicone emulsion antifoaming agents, polyether antifoaming agents, and fatty acid ester antifoaming agents.

The slurry for thermal spraying may further contain additives such as antiseptics or fungicides and antifreezing agents as needed. Examples of the antiseptic or the fungicide include isothiazoline compounds, azole compounds, and propylene glycol. Examples of the antifreezing agent include polyhydric alcohols such as ethylene glycol, diethylene glycol, propylene glycol, and glycerol.

When the above additives such as the agglomerating agent, the viscosity modifier, the antifoaming agent, the antiseptic, and the fungicide is used, any one of them can be used, or two or more of them can be used in combination. The total content of these additives can be roughly within a range from 0.01 to 10% by mass where the mass of spray particles is 100% by mass.

When additives such as a dispersant, a viscosity modifier, an agglomerating agent, a redispersibility improvement agent, an antifoaming agent, an antifreezing agent, an antiseptic, and a fungicide are used as optional components, such an additive can be added to a dispersion medium concurrently with spray particles or can be added separately at any timing, at the time of the preparation of the slurry for thermal spraying.

The above compounds exemplified as various additives can exhibit functions as other additives in addition to a principal purpose thereof. In other words, for example, a compound of the same type or a compound having the same composition can exhibit functions as two or more additives.

The slurry for thermal spraying prepared in this manner can be so prepared as to have a feeding performance index If of 70% or more, which is determined in accordance with the following procedure (1) to (3).

<Calculation of Feeding Performance Index If>

(1) Spray particles contained in 800 mL of a slurry for thermal spraying are weighed to give A kg.

(2) Through a tube that has an inner diameter of 5 mm and a length of 5 m and is placed horizontally, 800 mL of the slurry for thermal spraying in which the spray particles are in a dispersion state is allowed to flow at a flow rate of 35 mL/min, and the slurry is recovered. The spray particles contained in the recovered slurry are weighed to give B kg.

(3) Based on A and B, a value is calculated in accordance with the equation: If (%)=B/A×100 as the feeding performance index If.

The feeding performance index is an index capable of evaluating the feeding performance of spray particles in a slurry for thermal spraying to a thermal spraying apparatus. By specifying the feeding performance index If of 800 mL of a slurry for thermal spraying, the feeding performance of a slurry for thermal spraying usable in various thermal spraying conditions (for example, larger scale thermal spraying conditions) can be more appropriately evaluated. In addition, by increasing the feeding performance index value, the absolute value of the zeta potential in a slurry for thermal spraying can be allowed to approach to a favorable value (for example, 0 mV). Consequently, various design standards for a slurry for thermal spraying that can be subjected to satisfactory thermal spraying in various thermal spraying conditions can be obtained.

By specifying the feeding rate to a flow rate of 35 mL/min, a turbulent flow can be generated in a slurry for thermal spraying flowing through a tube having the above dimensions. By generating such a turbulent flow, the feeding performance of a slurry can be evaluated while the extrusion force of the slurry and the dispersibility of the spray particles are increased. The material of the tube used for the evaluation of the feeding performance is not strictly limited, but in order to achieve smooth feeding conditions of a slurry for thermal spraying, a tube made from a flexible resin such as polyurethane, polyvinyl chloride, and polytetrafluoroethylene is preferably used. In order to observe spray particles flowing in a tube from outside, a transparent or translucent tube can also be used.

In the technique disclosed here, when the feeding performance index If is 70% or more, the feeding performance of spray particles to a thermal spraying apparatus is determined to be sufficient. The feeding performance index If is preferably 75% or more, more preferably 80% or more, even more preferably 85% or more, and, for example, further preferably 90% or more (ideally, 100%). In a slurry for thermal spraying satisfying such a feeding performance index, spray particles are prevented from sedimenting when the slurry is fed to a thermal spraying apparatus, and accordingly, a larger amount of spray particles can be fed to a thermal spraying apparatus. In addition, the slurry concentration is unlikely to differ between immediately after the start of feeding of a slurry for thermal spraying and the end of the feeding. This allows spray particles to be stably fed to a thermal spraying apparatus at high efficiency, and a high quality sprayed coating can be formed. p In such a slurry for thermal spraying, the proportion of spray particles is not limited to particular values. For example, the proportion of spray particles in the whole slurry for thermal spraying is preferably 10% by mass or more, more preferably 15% by mass or more, and can be, for example, 20% by mass or more. When the solid content concentration is 10% by mass or more, the thickness of a sprayed coating produced from the slurry for thermal spraying per unit time can be increased. In other words, the thermal spraying efficiency can be improved.

In the slurry for thermal spraying, the proportion of spray particles can be 70% by mass or less, preferably 65% by mass or less, and, for example, 50% by mass or less. When the solid content concentration is 70% by mass or less, flowability suited for feeding a slurry for thermal spraying to a thermal spraying apparatus can be achieved.

The viscosity of the slurry for thermal spraying can be, but is not necessarily limited to, 1,000 mPa·s or less, preferably 500 mPa·s or less, more preferably 100 mPa·s or less, and, for example, 50 mPa·s or less. When the slurry for thermal spraying have a lower viscosity, the flowability can be further improved. The lower limit of the viscosity of the slurry for thermal spraying is not limited to particular values, but a slurry for thermal spraying having a lower viscosity can mean a lower proportion of particles for thermal spraying. From such a viewpoint, the viscosity of the slurry for thermal spraying is, for example, preferably 0.1 mPa·s or more, more preferably 5 mPa·s or more, and even more preferably 10 mPa·s or more. By adjusting the viscosity of a slurry for thermal spraying within the above range, the feeding performance index can be adjusted to a preferred range.

The pH of the slurry for thermal spraying is not limited to particular values, but is preferably 2 or more and 12 or less. In terms of easy handling of the slurry for thermal spraying, the pH is preferably 6 or more and 8 or less. For example, in order to control the zeta potential of spray particles, the pH may be a value out of a range of 6 or more and 8 or less, and may be 7 or more and 11 or less, or 3 or more and 7 or less, for example.

The pH of the slurry for thermal spraying can be controlled by known various acids, bases, or salts thereof. Specifically, organic acids such as carboxylic acid, organic phosphonic acids, and organic sulfonic acids; inorganic acids such as phosphoric acid, phosphorous acid, sulfuric acid, nitric acid, hydrochloric acid, boric acid, and carbonic acid; organic bases such as tetramethylammonium hydroxide, trimethanolamine, and monoethanolamine; inorganic bases such as potassium hydroxide, sodium hydroxide, and ammonia; and salts thereof are preferably used.

The pH of a slurry for thermal spraying can be a value determined. by using a glass electrode pH meter (for example, manufactured by Horiba, Ltd., Benchtop pH meter (F-72)) with authentic pH standard solutions (for example, a phthalate pH standard solution (pH: 4.005/25° C.), a neutral phosphate pH standard solution (pH: 6.865/25° C.), and a carbonate pH standard solution (pH: 10.012/25° C.)) in accordance with JIS Z8802:2011.

In the slurry for thermal spraying, spray particles preferably form secondary particles. By controlling the amount and the average particle size of secondary particles including spray particles, the zeta potential can be controlled. Whether spray particles form secondary particles can be estimated by measuring the average particle size of spray particles in a slurry and comparing the value with the average particle size of spray particles (dry powder) prepared for a slurry for thermal spraying. For example, when the average particle size after the preparation of a slurry is 1.2 or more times (more preferably 1.5 or more times) larger than that before the preparation, it can be determined that almost all the spray particles form secondary particles. In contrast, when the average particle size after the preparation of a slurry is less than 1.2 times larger than that before the preparation and is not greatly changed, it can be determined that the spray particles are prevented from forming secondary particles. The average particle size of spray particles in a slurry is, for example, a 50% cumulative particle size (D₅₀) in volumetric particle size distribution measured by using a laser diffraction/scattering particle size distribution analyzer (manufactured by Horiba, Ltd., LA-950). By calculating a 3% cumulative particle size (D₃) and a 97% cumulative particle size (D₉₇) in volumetric particle size distribution of spray particles concurrently with the measurement of the average particle size, a variation in average particle size (formation condition of secondary particles) can be estimated. The average particle size of the secondary particles formed from spray particles in a slurry for thermal spraying is preferably 30 μm or less, more preferably 25 μm or less, and even more preferably 15 μm or less. The increase degree of the average particle size of secondary particles of spray particles in a slurry for thermal spraying relative to the primary particle size of the spray particles before the preparation of the slurry for thermal spraying can also be determined. For example, the average particle size of secondary particles formed from spray particles in a slurry for thermal spraying is preferably 1.2 or more times larger than the primary particle size of the spray particles before the preparation of the slurry for thermal spraying.

[Materials for Preparation of slurry For Thermal Spraying]

As described above, the slurry for thermal spraying disclosed here can surely achieve good redispersibility by a treatment such as second shaking even when particles for thermal spraying precipitate. Hence, for example, the slurry for thermal spraying in which particles for thermal spraying have precipitated can be divided into a portion that does not contain the particles for thermal spraying or contains the particles in a smaller amount (typically, a supernatant liquid portion) and a portion that contains all the particles for thermal spraying or contains the particles in a larger amount (typically, a remainder portion after removal of the supernatant liquid portion). The portions can be appropriately mixed and stirred, for example, to give the above slurry for thermal spraying. Alternatively, the components of the slurry for thermal spraying can be separately prepared as some component portions, and then the portions can be appropriately mixed and stirred, for example, to give the above slurry for thermal spraying. Thus, the slurry for thermal spraying can also be prepared in the following manner: the respective components constituting the slurry for thermal spraying are stored in separate containers each containing a single component or a mixture of two or more components, and the components are mixed before thermal spraying.

From such a viewpoint, the technique disclosed here provides a material for preparing a slurry for thermal spraying used for preparing the slurry for thermal spraying. The preparation material includes at least one or more of the components constituting the above slurry for thermal spraying.

In addition, the material is so constituted as to satisfy a feeding performance index If of 70% or more when all the components that constitute a slurry for thermal spraying and include the preparation material are mixed to prepare a mixed liquid.

The preparation material may be only some of the components constituting a slurry for thermal spraying. The preparation material may be so constituted as to give a slurry for thermal spraying containing all the components by combining a preparation material A with another preparation material B or with two or more preparation materials B, C, etc. As the components constituting a slurry for thermal spraying, the above optional components (additives) such as a dispersant and a viscosity modifier can be included, for example, in addition to the spray particles and the dispersion medium. Hence, the combination of such a preparation material is specifically exemplified by the following constitutions.

### EXAMPLE 1

Preparation material A1: particles for thermal spraying

Preparation material B1: a dispersion medium

### EXAMPLE 2

Preparation material A2: particles for thermal spraying and some of a dispersion medium

Preparation material B2: the remainder of the dispersion medium

### EXAMPLE 3

Preparation material A3: particles for thermal spraying

Preparation material B3: a dispersion medium and optional components (additives)

### EXAMPLE 4

Preparation material A4: particles for thermal spraying

Preparation material B4: a dispersion medium

Preparation material C4: optional components (additives)

When a plurality of optional components are used here, the preparation material C4 may include preparation materials C4n (n is natural numbers) of the respective optional components, for example.

In this manner, in the material for preparing a slurry for thermal spraying disclosed here, the respective components constituting a slurry for thermal spraying, such as spray particles, a dispersion medium, a dispersant, and other optional components, may be provided in separate packages each containing a single component or a mixture of two or more components. The material for preparing a slurry for thermal spraying may be mixed with other components (optionally other materials for preparing a slurry for thermal spraying) before thermal spraying to give a slurry for thermal spraying. From the viewpoint of easy transportation, it is preferred that components other than a dispersion medium be prepared in a single package as a material for preparing a slurry for thermal spraying, and the dispersion medium be prepared in another package as a material for preparing a slurry for thermal spraying (optionally another material for preparing a slurry for thermal spraying). Components other than the dispersion medium (particles for thermal spraying and optional components such as additives) can be in a powder (solid) form, for example. For example, when the dispersion medium is an easy available material such as water, a user of the slurry for thermal spraying can independently prepare such a dispersion medium. In terms of uniformity of a slurry for thermal spraying or stable performance of a coating, the slurry for thermal spraying to be subjected to thermal spraying is preferably prepared as a high concentration slurry containing spray particles at a higher concentration.

The above material for preparing a slurry for thermal spraying may include information for preparing a slurry for thermal spraying. The information can also be understood as the preparation method for preparing a slurry for thermal spraying by using the material for preparing a slurry for thermal spraying. For example, information about the procedure of mixing components in separate packages or about materials required in addition to the material for preparing a slurry for thermal spraying is displayed. Although the material for preparing a slurry for thermal spraying is so constructed as to give a feeding performance index If of 70% or more, information for further improving the If value may be displayed. Such information may be displayed on the containers of components or on a covering material or the like in which such a container is stored. Alternatively, a paper sheet or the like on which information is described may be set (packed) in the container of a component. The information can be so constructed as to be available by a user having the material for preparing a slurry for thermal spraying through the Internet or the like. Accordingly, the material for preparing a slurry for thermal spraying disclosed here can be used to more easily and certainly form a sprayed coating at high efficiency.

[Coating Formation Method]

(Substrate)

In the method for forming a sprayed coating disclosed here, the substrate on which a sprayed coating is formed is not limited to particular substrates. For example, any substrate made from various materials can be used as long as the substrate is made from a material that can have an intended resistance when the substrate is subjected to the thermal spraying. Examples of such a material include various metals and alloys. Such a material is specifically exemplified by aluminum, aluminum alloys, iron, steel, copper, copper alloys, nickel, nickel alloys, gold, silver, bismuth, manganese, zinc, and zinc alloys. Of them, substrates made of steels typified by various SUS materials having comparatively high thermal expansion coefficients in general purpose metal materials (optionally what is called stainless steel), heat-resistant alloys typified by inconel, low-expansion alloys typified by invar and kovar, corrosion-resistant alloys typified by hastelloy, and aluminum alloys typified by 1,000 series to 7,000 series aluminum alloys that are useful as lightweight structural materials and the like are exemplified.

(Coating Formation Method)

The slurry for thermal spraying disclosed here can be subjected to a thermal spraying apparatus based on a known thermal spraying method and thus can be used as the material for thermal spraying in order to form a sprayed coating. When the slurry for thermal spraying is allowed to stand for a certain period of time typically for storage, the spray particles can start to sediment and precipitate in a dispersion medium. Hence, the slurry for thermal spraying in the technique disclosed here can be so prepared as to give a feeding performance index If of 70% or more, which is determined by the above procedure, when the slurry is subjected to thermal spraying (for example, in the preparation step for feeding the slurry to a thermal spraying apparatus). For example, a slurry for thermal spraying in a storage state before thermal spraying (also called a precursor liquid) can be prepared as a high concentration slurry containing spray particles at a higher concentration.

As the thermal spray method of appropriately, thermally spraying the slurry for thermal spraying, a thermal spray method such as plasma spraying and high velocity flame spraying can be preferably adopted, for example.

The plasma spraying is a thermal spray method that uses a plasma flame as a thermal spraying heat source for softening or melting a thermal spraying material. Between electrodes, arc is generated, and the arc functions to convert a working gas into plasma. Such a plasma flow is ejected from a nozzle as a plasma jet at high temperature and high speed. The plasma spraying generally encompasses coating techniques in which a material for thermal spraying is introduced to the plasma jet, then heated and accelerated, and deposited on a substrate to form a sprayed coating. The plasma spraying can be atmospheric plasma spraying (APS) that is performed in the atmosphere, low pressure plasma spraying (LPS) in which thermal spraying is performed at a lower pressure than the atmospheric pressure, or high pressure plasma spraying in which plasma spraying is performed in a pressurized container at a higher pressure than the atmospheric pressure, for example. In such plasma spraying, by using a plasma jet at about 5,000° C. to 10,000° C. to melt and accelerate a thermal spraying material, the spray particles can be hit against a substrate at a speed of about 300 m/s to 600 m/s and deposited, for example.

The high velocity flame spraying can be high velocity oxygen fuel (HVOF) thermal spraying, warm spray thermal spraying, or high velocity air fuel (HVAF) flame spraying, for example.

The HVOF thermal spraying is a flame spraying that uses a combustion flame prepared by burning a mixture of a fuel and oxygen at high pressure, as the heat source for thermal spraying. By increasing the pressure in a combustion chamber, a continuous combustion flame is ejected from a nozzle at high speed (optionally supersonic speed) as a high temperature gas flow. The HVOF thermal spraying generally encompasses coating techniques in which a material for thermal spraying is introduced to the gas flow, then heated and accelerated, and deposited on a substrate to form a sprayed coating. In the HVOF thermal spraying, for example, by feeding a slurry for thermal spraying to a supersonic combustion flame jet at 2,000° C. to 3,000° C., a dispersion medium can be removed (optionally burned or evaporated, hereinafter, the same applies) from the slurry. Concurrently, the spray particles can be softened and melted, then hit against a substrate at a high speed of 500 m/s to 1,000 m/s, and deposited. The fuel used for the high velocity flame spraying may be a hydrocarbon gas fuel such as acetylene, ethylene, propane, and propylene or may be a liquid fuel such as kerosene and ethanol. As a thermal spraying material has a higher melting point, the temperature of the supersonic combustion flame is preferably higher. From this viewpoint, a gas fuel is preferably used.

Alternatively, a thermal spraying method called warm spray thermal spraying to which the HVOF thermal spraying is applied can be adopted. The warm spray thermal spraying is typically a technique in which thermal spraying is performed in a condition where the combustion flame in the HVOF thermal spraying is mixed with a cooling gas including nitrogen or the like at around room temperature to reduce the temperature of the combustion flame, thereby forming a sprayed coating. The thermal spraying material when subjected to thermal spraying is not necessarily, completely melted, but may be partially melted or may be in a softened state at a temperature not higher than the melting point thereof, for example. In the warm spray thermal spraying, for example, by feeding a slurry for thermal spraying to a supersonic combustion flame jet at 1,000° C. to 2,000° C., a dispersion medium can be removed (optionally burned or evaporated, hereinafter, the same applies) from the slurry. Concurrently, the spray particles can be softened and melted, then hit against a substrate at a high speed of 500 m/s to 1,000 m/s, and deposited.

The HVAF thermal spraying is a thermal spraying method in which air is fed in place of oxygen as a combustion support gas in the HVOF thermal spraying. By the HVAF thermal spraying, the thermal spraying temperature can be lowered as compared with the HVOF thermal spraying. For example, by feeding a slurry for thermal spraying to a supersonic combustion flame jet at 1,600° C. to 2,000° C., a dispersion medium can be removed (optionally burned or evaporated, hereinafter, the same applies) from the slurry. Concurrently, the spray particles can be softened and melted, then the spray particles can be hit against a substrate at a high speed of 500 m/s to 1,000 m/s, and can be deposited.

In the invention disclosed here, when the slurry for thermal spraying is preferably subjected to high velocity flame spraying or plasma spraying because a material for thermal spraying even having a comparatively large particle size can be sufficiently softened and melted, a slurry for thermal spraying including spray particles even at a high content can be thermally sprayed with good flowability, and a dense sprayed coating can be efficiently formed.

Although not critical, the slurry for thermal spraying is fed to a thermal spraying apparatus preferably at a flow rate of 10 mL/min or more and 200 mL/min or less. When the slurry for thermal spraying is fed at a rate of about 10 mL/min or more, the slurry that is flowing in a device for feeding a slurry for thermal spraying (for example, a slurry feed tube) can be made in a turbulent flow state, and the extrusion force of the slurry can be increased. In addition, the spray particles can be prevented from sedimenting. Such a condition is thus preferred. From such a viewpoint, the flow rate when the slurry for thermal spraying is fed is preferably 20 mL/min or more and more preferably 30 mL/min or more. Meanwhile, when the feeding rate is excessively high, the amount of the slurry may exceed the amount of a slurry that can be thermally sprayed from a thermal spraying apparatus, and thus such a condition is unfavorable. From such a viewpoint, the flow rate when the slurry for thermal spraying is fed is appropriately 200 mL/min or less, preferably 150 mL/min or less, and more preferably 100 mL/min or less, for example.

The slurry for thermal spraying is fed to a thermal spraying apparatus preferably by an axial feed system. In other words, the slurry for thermal spraying is fed preferably in the same direction as the axis of a jet flow generated in a thermal spraying apparatus. For example, when the slurry for thermal spraying of the present invention in a slurry state is fed by the axial feed system to a thermal spraying apparatus, the thermal spraying material in the slurry for thermal spraying is unlikely to adhere to the inside of the thermal spraying apparatus because the slurry for thermal spraying has good flowability. Consequently, a dense sprayed coating can be efficiently formed. Such a condition is thus preferred.

When a common feeder is used to feed the slurry for thermal spraying to a thermal spraying apparatus, the feed amount varies periodically, and thus stable feeding may be difficult. When the feed amount of the slurry for thermal spraying oscillates due to the periodic variation of the feed amount, the thermal spraying material is unlikely to be uniformly heated in a thermal spraying apparatus, and an uneven sprayed coating can be formed in some cases. In order to stably feed the slurry for thermal spraying to a thermal spraying apparatus, a two-stroke system, or two feeders may be used in such a manner that variable periods of the feed amounts of the slurry for thermal spraying from both the feeders have opposite phases to each other. Specifically, the feeding system can be controlled to give such periods that when the feed amount of one feeder increases, the feed amount of the other feeder decreases, for example. When the slurry for thermal spraying of the present invention is fed to a thermal spraying apparatus by the two-stroke system, a dense sprayed coating can be efficiently formed because the slurry for thermal spraying has good flowability.

As the means for stably feeding a material for thermal spraying in a slurry form to a thermal spraying apparatus, the slurry sent from a feeder may be once stored in a storage tank provided just before the thermal spraying apparatus, and the slurry may be fed from the storage tank to the thermal spraying apparatus by using natural drop. Alternatively, the slurry in the tank may be forcedly fed to the thermal spraying apparatus by using a means such as a pump. When the slurry is forcedly fed by a means such as a pump, a thermal spraying material in the slurry is unlikely to adhere to the inside of a tube that connects the tank and the thermal spraying apparatus. Such a condition is thus preferred. In order to uniformize the distribution state of components in the slurry for thermal spraying in the tank, a means of stirring the slurry for thermal spraying in the tank may be provided.

The slurry for thermal spraying is fed to a thermal spraying apparatus preferably through a metal conductive tube, for example. When a conductive tube is used, static electricity can be prevented from generating, and thus the feed amount of the slurry for thermal spraying is unlikely to vary. The inner surface of the conductive tube preferably has a surface roughness Ra of 0.2 μm or less.

A thermal spraying distance is the distance from the tip of a nozzle of a thermal spraying apparatus to a substrate and is preferably set to 30 mm or more. When the thermal spraying distance is excessively small, the time for removing a dispersion medium in the slurry for thermal spraying or for softening/melting spray particles may be insufficiently secured, or a thermal spraying heat source is excessively close to a substrate, and thus the substrate may deteriorate or be deformed. Such a condition is therefore unfavorable.

The thermal spraying distance is preferably about 200 mm or less (preferably 150 mm or less, for example, 100 mm or less). Such a distance allows spray particles sufficiently heated to reach to a substrate while the temperature is maintained, and thus a denser sprayed coating can be produced.

For thermal spraying, a substrate is cooled preferably from the side opposite to the side undergoing thermal spraying. Such cooling can be water cooling or cooling with an appropriate refrigerant.

(Sprayed Coating)

By the technique disclosed here, a sprayed coating including a compound having the same composition as spray particles and/or a degradation product thereof is formed.

The sprayed coating is formed by using a slurry for thermal spraying in which spray particles have an absolute zeta potential of 200 mV or less and are satisfactory dispersed. Thus, spray particles are maintained in an appropriate dispersion state and a flow state in the slurry for thermal spraying, are stably fed to a thermal spraying apparatus, and form a uniform sprayed coating. The spray particles are not hit by a flame or a jet but can be efficiently fed to the vicinity of the center of a heat source and sufficiently softened or melted. Hence, the softened or melted spray particles densely adhere to a substrate and to each other with good adhesiveness. Accordingly, a sprayed coating having good uniformity and adhesiveness is formed at an appropriate coating forming speed.

Some examples of the present invention will next be described, but the present invention is not intended to be limited to these examples.

[Preparation of Slurry for Thermal Spraying]

As spray particles, yttria (Y₂O₃), alumina (Al₂O₃), yttrium fluoride (YF₃), and yttrium oxyfluorides having various compositions (YOF, Y₅O₄F₇, Y₆O₅F₈, Y₇O₆F₉) , having the corresponding average particle sizes shown in Table 1 were prepared. As dispersion media, distilled water was prepared as an aqueous dispersion medium, and a mixed solvent containing ethanol (EtOH), isopropyl alcohol (i-PrOH), and n-propyl alcohol (n-PrOH) at 85:5:10 in terms of volume ratio was prepared as a nonaqueous dispersion medium. As additives as optional components, dispersants and a viscosity modifier were prepared. As the dispersant, any of an aqueous nonionic surfactant-type dispersant (manufactured by Dai-ichi Kogyo Seiyaku Co., Ltd., Noigen XL-400) and a nonaqueous special polycarboxylic acid polymer surfactant (manufactured by Kao Corporation, HOMOGENOL L-18) was used. As the viscosity modifier, an anionic special modified polyvinyl alcohol (PVOH) (manufactured by The Nippon Synthetic Chemical Industry Co., Ltd., Gohsenx L-3266) was used. Such particles for thermal spraying and a dispersion medium were prepared in different containers in such a manner that the proportion of particles for thermal spraying would be 30% by mass.

The particles for thermal spraying and the dispersion medium were mixed together with a dispersant and a viscosity modifier in accordance with the formulations shown in Table 1, giving slurries for thermal spraying of Examples 1 to 27 each having a proportion of particles for thermal spraying of 30% by mass. In the present embodiment, the amount of the viscosity modifier was constant at 0.1% by mass relative to the mass of spray particles. In Table 1, “-” in the viscosity modifier column means that no viscosity modifier was used. The amount of a dispersant was appropriately controlled while the dispersion state of spray particles in a slurry for thermal spraying was observed, and the amounts used are indicated in the “content” column in Table 1.

[Presence or Absence of Secondary Particles Formed]

The average particle size of the spray particles in each slurry for thermal spraying prepared was determined by using a laser diffraction/scattering particle size distribution analyzer (manufactured by Horiba, Ltd., LA-950). The average particle size of the spray particles in the slurry was compared with the average primary particle size of spray particles prepared for the slurry for thermal spraying. When the average particle size of the spray particles in the slurry was 1.5 or more times larger, it was determined that the spray particles agglomerate to form secondary particles in the slurry. An example in which spray particles are determined to form secondary particles is indicated by “presence” in the secondary particle formation column in Table 1, and an example in which spray particles are determined not to form secondary particles is indicated by “absence”.

[Viscosity]

The viscosity of each slurry for thermal spraying prepared was determined by using a viscometer (manufactured by Rion, Viscotester VT-03F) in a room temperature (25° C.) environment at a rotation speed of 62.5 rpm. The results are shown in Table 1.

[Zeta Potential]

The zeta potential of the spray particles in each slurry for thermal spraying prepared was determined by using an ultrasonic particle size distribution/zeta potential analyzer (manufactured by Dispersion Technology, DT-1200).

[Feeding Performance Index If]

The feeding performance index If of each slurry for thermal spraying prepared was determined by the following procedure. In other words, first, a polyurethane tube (manufactured by CHIYODA, Touch Tube (urethane) TE-8 with an outer diameter of 8 mm and an inner diameter of 5 mm) having an inner diameter of 5 mm and a length of 5 m was placed on a test table with no difference in height. To one end of the tube, a roller pump for feeding a slurry was connected, and to the other end, a slurry recovery container was connected.

A prepared slurry for thermal spraying was stirred with a magnetic stirrer, and good dispersion state of the spray particles was ascertained. The slurry was then fed into the tube at a flow rate of 35 mL/min. The slurry for thermal spraying that had passed through the tube was recovered in the recovery container, and the spray particles contained in the recovered slurry was weighed to give mass B. From the previously determined mass A of the spray particles contained in 800 mL of the slurry for thermal spraying after preparation and the mass B of the spray particles contained in the recovered slurry, the feeding performance index If was calculated in accordance with the following equation, and the results are shown in Table 1.

If(%)=B/A×100

[Formation of Sprayed Coating]

Each slurry for thermal spraying prepared above was used and thermally sprayed by an atmospheric plasma spraying (APS) method to form a sprayed coating. The thermal spraying conditions were as shown below.

In other words, first, a SS400 steel plate (70 mm×50 mm×2.3 mm) was prepared and was subjected to roughening treatment, and the product was used as the substrate to be subjected to thermal spraying. For APS thermal spraying, a commercially available plasma spraying apparatus (manufactured by Praxair, SG-100) was used. As for plasma generation conditions, at atmospheric pressure, argon gas was fed at a pressure of 100 psi, helium gas was fed at a pressure of 90 psi as plasma working gases, and the plasma generation power was 40 kW. To feed a slurry for thermal spraying to a thermal spraying apparatus, a slurry feeder was used to feed the slurry at a feed amount of about 100 mL/min to a burner chamber in the thermal spraying apparatus. When the slurry was fed to the thermal spraying apparatus, a storage tank was install adjacent to the thermal spraying apparatus, the prepared slurry for thermal spraying was once stored in the storage tank, and then the slurry was fed from the storage tank to the thermal spraying apparatus by using natural drop. A plasma jet was ejected from a nozzle of the thermal spraying apparatus, and the slurry for thermal spraying fed to the burner chamber was allowed to fly together with the jet while the dispersion medium in the slurry was removed. Concurrently, the spray particles were melted and were sprayed to a substrate, and consequently a coating was formed on the substrate. The conveyance speed of a thermal spraying gun was 600 mm/min, and the thermal spraying distance was 50 mm.

[Coating Formation Efficiency]

The coating formation efficiency (adhesion efficiency) of spray particles was evaluated when the slurry for thermal spraying of each example was thermally sprayed to form a coating. Specifically, the thickness (μm) of a sprayed coating formed by a single pass (which means that thermal spraying is performed once from a thermal spraying apparatus to a substrate) in the above thermal spraying conditions was determined. In the present embodiment, when the coating formation efficiency is 2.5 μm or more by a single pass, the formation efficiency is evaluated as good. [Table 1]

As shown in Table 1, it was revealed that the coating formation efficiency greatly varies as slurries for thermal spraying have different zeta potentials even when spray particles have the same composition and the same average particle size and are contained in the same amount (at the same concentration) as shown in Examples 1 to 16. It was further revealed that a good coating formation efficiency of 2.5 μm or more is achieved when the absolute value of the zeta potential is 200 mV or less. A higher coating formation efficiency means that a slurry for thermal spraying fed to a thermal spraying apparatus has good flowability and good feeding performance.

It was also revealed that in the slurry for thermal spraying having good coating formation efficiency, the spray particles form secondary particles. The result suggests that in the slurry for thermal spraying disclosed here, primary particles of spray particles agglomerate to give a certain size, and accordingly the agglomeration particles (secondary particles) are stably dispersed in the flowing slurry for thermal spraying. It was ascertained that as a result, a slurry for thermal spraying having an absolute zeta potential of 200 mV or less had good feeding performance, which was indicated by a feeding performance index If of 70% or more.

Specific examples of the present invention have been described in detail hereinbefore, but are merely illustrative examples, and are not intended to limit the scope of claims. The techniques described in the scope of claims include various modifications and changes of the above exemplified specific examples. For example, in the above embodiment, slurries for thermal spraying were so prepared as to have various zeta potentials while the types of the dispersant and the viscosity modifier were fixed. However, selection and use of additives such as a dispersant and a viscosity modifier suitable for controlling the zeta potential can be understood by a person skilled in the art on the basis of teachings disclosed here and common general knowledge at the time of patent application.

What is claimed is:

1. A slurry for thermal spraying, the slurry comprising:
spray particles including at least one material selected from the group consisting of ceramics, inorganic compounds, cermets, and metals; and
a dispersion medium,
wherein the spray particles have an average particle size of 0.01 μm or more and 10 μm or less, the spray particles are contained in the slurry for thermal spraying at a proportion of 10% by mass or more and 70% by mass or less, and
in the slurry for thermal spraying, the spray particles have a zeta potential of −200 mV or more and 200 mV or less.

2. The slurry for thermal spraying according to claim 1, further comprising a dispersant.

3. The slurry for thermal spraying according to claim 1, wherein at least some of the spray particles include an yttrium oxyfluoride.

4. The slurry for thermal spraying according to claim 1, wherein at least some of the spray particles include a rare earth halide.

5. The slurry for thermal spraying according to claim 1, wherein the slurry for thermal spraying has a viscosity of 1,000 mPa·s or less.

6. The slurry for thermal spraying according to claim 1, wherein the dispersion medium is an aqueous dispersion medium.

7. The slurry for thermal spraying according to claim 1, wherein the dispersion medium is a nonaqueous dispersion medium.

8. A sprayed coating including a thermal spray product of the slurry for thermal spraying according to claim 1.
